(19) United States
(12) Patent Application Publication
(10) Pub. No.: US 2003/0228869 A1
(43) Pub. Date: Dec. 11, 2003

(54) Providing mobility in a distributed end-to-end packet/cell/frame network

(76) Inventors: Albert Chow, Hillsdale, NJ (US); Kenny Xiaojian Huang, Brooklyn, NY (US); Jinman Kim, Florham Park, NJ (US); Wenchu Ying, Cedar Knolls, NJ (US)

Correspondence Address: KENYON & KENYON, 1500 K STREET, N.W., SUITE 700, WASHINGTON, DC, 20005, US

(21) Appl. No.: 10/163,500

(22) Filed: Jun. 7, 2002

(51) Int. Cl. H04Q 7/20

(52) U.S. Cl. 455/432.2; 455/435.1; 455/432.3; 455/435.2; 455/422.1; 455/445

(57) ABSTRACT

Embodiments of a system and method of supporting a broadband telecommunication service enable enhanced mobility and personalization. Storage of registration information to a memory of a portable upgrade module is permitted, and a registration message is transmitted over a packet switched network to a home network access server platform (NASP) based on the registration information. The home NASP is associated with a home environment. A default service capability of a terminal located in a remote environment is upgraded based on a home service capability. The upgraded default service capability enables the terminal to receive the telecommunication service in accordance with the home service capability. In one embodiment, the portable upgrade module constitutes a smart card, and in another environment the module is a personal computer (PC) card.

### CROSS-REFERENCE TO RELATED APPLICATIONS

The present application is related to the application of Albert Chow et al., entitled “Broadband Telecommunication Service With Personalized Service Capability For Mobile Terminals”, filed on even date herewith.

### TECHNICAL FIELD

Embodiments of the present invention generally relate to broadband telecommunication services. More particularly, embodiments relate to methods and systems of providing broadband telecommunications services over packet switched networks that use upgrade modules to maintain personalized service.

### BACKGROUND OF THE INVENTION

Telecommunications services are critical to a wide variety of industries and daily activities, and have long been integral to the functioning of society. For example it is well documented that voice, data and multimedia applications have all proven to be useful in one circumstance or another. Indeed, there is a rapidly increasing demand to integrate these various types of applications into a seamless fabric of telecommunication services. While the trend toward integrated telecommunication services is quite desirable to the consumer, a number of challenges remain.

From a telecommunication standpoint, the integration of the above and other applications has been facilitated by the evolution from traditional analog networks to broadband networks. Broadband networks use digital technology to make more efficient use of the transmission capacity of the physical architecture being used. For example, broadband architectures based on cable, hybrid fiber coaxial cable (HFC) and the digital subscriber line family of technologies (×DSL) have enabled leased line transmission rates in excess of 1.544 Mbs (i.e., T1+). Thus, higher transmission rates have provided an opportunity to increase the number and quality of telecommunication services available to the end user. It should be noted, however, that conventional approaches to managing these services need to be improved. For example, the service criteria associated with integrated telecommunication applications enabled by broadband networks can be too complicated for traditional circuit switch approaches to establishing links. Establishing telecommunication links is particularly important when dealing with mobile terminals such as laptop, personal digital assistants (PDA's), cellular phones, etc. Unfortunately, circuit switch-facilitated dial tone and numbering schemes such as directory number (DN), E.164 cannot support the sophisticated user-to-network interaction required to fulfill and communicate all of the service criteria. For example, criteria such as service and feature selections, maintenance of personal address books and directories, profiles and databases, and service preferences are all aspects of an integrated broadband service that might be customized or identified when a mobile terminal establishes a link. Thus, the simplicity of the traditional telephone keypad can not fulfill these needs.

There is, therefore, a need to make use of multi-module user-interfaces such as speech/voice recognition to enable the consumer to interact with the network in a more human/natural, and sophisticated manner. In particular, in dealing with a mobile terminal, conventional approaches are significantly limited with regard to service capability. For example, if a mobile terminal is registered in a remote environment under conventional approaches, the telecommunications service must be provided to the mobile terminal in accordance with the service capability of the remote environment. As a result, a subscriber having a terminal with an associated home service capability (such as enhanced video capability) might be forced to communicate in accordance with an entry-level service such as 64 Kbps video. There is therefore a need to provide a mobile terminal with personalized telecommunications service capability.

### SUMMARY OF THE INVENTION

Exemplary embodiments of the present invention provide a system and method of supporting a broadband telecommunication service. The method and system provide for transferring registration information to a memory of a portable upgrade module, where the portable upgrade module is connected to a home terminal having a home service capability. A registration message is received from the upgrade when the upgrade module is connected to a remote terminal which is located in a remote environment. A signal is transmitted to cause the upgrade module to change a default service capability of the remote terminal based on the home service capability. The changed default service capability enables the remote terminal to receive the telecommunication service in accordance with the home service capability. By changing the default service capability, an improved level of personalization can be achieved.

In other exemplary embodiments, a system and method of upgrading a default service capability of a terminal located in a remote environment is provided. Profile information is sent to a portable upgrade module over a network, where the profile information enables the upgrade module to extract a home service capability. The profile information also enables the upgrade module to modify the default service capability based on the home service capability. In one particular embodiment, the telecommunication service is a broadband video conferencing service. In another embodiment, a machine readable storage medium is provided, where the storage medium stores a set of instructions capable of being executed by a processor to support a broadband telecommunications service.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute part of this specification. The drawings illustrate various features and embodiments of the invention, and together with the description serve to explain the principles and operation of the invention.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a diagram of an example of multiple environments in which a portable upgrade module can be used in accordance with one embodiment of the present invention;

FIG. 2 is a diagram of an example of a networking architecture in accordance with one embodiment of the present invention;

FIG. 3 is a timing diagram of an example of a call flow in accordance with one embodiment of the presentation invention;

FIG. 4 is a flowchart of an example of a computer implemented method of supporting a broadband telecommunication service in accordance with one embodiment of the invention;

FIG. 5 is a flowchart of an example of a computer implemented method of upgrading a default service capability of a terminal located in a remote environment in accordance with one embodiment of the invention; and

FIG. 6 is a flowchart of an of an example of a process of receiving a registration message at a home network access server platform in accordance with one embodiment of the invention.

### DETAILED DESCRIPTION

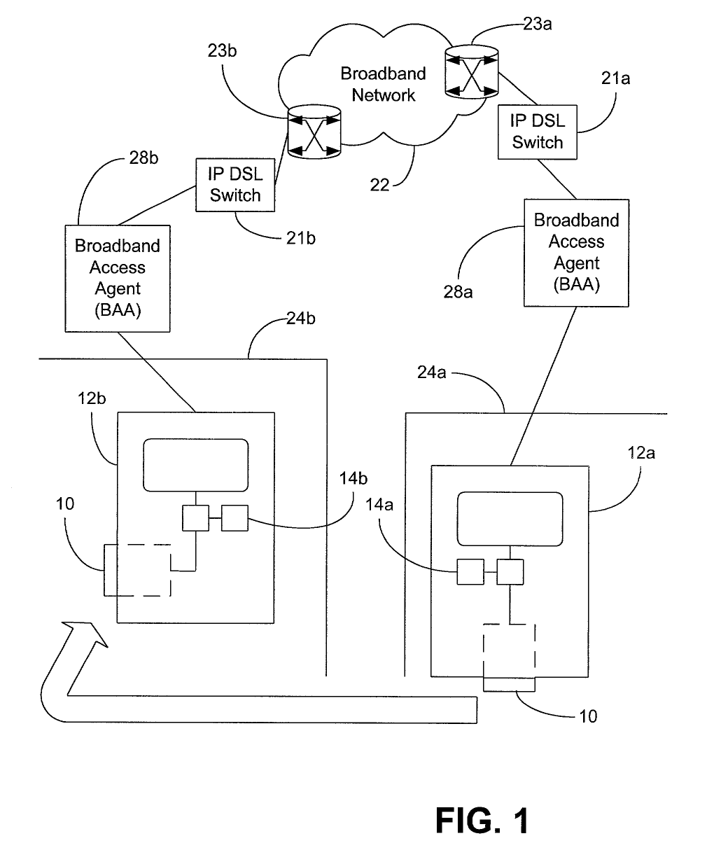

FIG. 1 demonstrates an exemplary situation in which a portable upgrade module 10 can provide enhanced mobility in a distributed end-to-end packet/cell/frame network. Generally, the upgrade module 10 can enable a subscriber/user to travel from a home environment 24a to a remote environment 24b and maintain the ability to receive services in accordance with a home service capability 14a. For example, a home terminal 12a might be a videophone supporting 384 Kbps video with conferencing capabilities. A remote terminal 12b, however, might be a videophone that has a default service capability 14b of 64 Kbps video. It will be appreciated that the subscriber may wish to use the remote terminal 12b in conjunction with the home service capability 14a as opposed to the default service capability 14b.

It should be noted that although the embodiments discussed herein will be primarily described with regard to videophones, the embodiments of the invention are not so limited. Indeed, the approaches described herein can be useful for any terminal in which personalization and mobility is desired. Notwithstanding, there are a number of aspects of videophones for which the embodiments are uniquely suited.

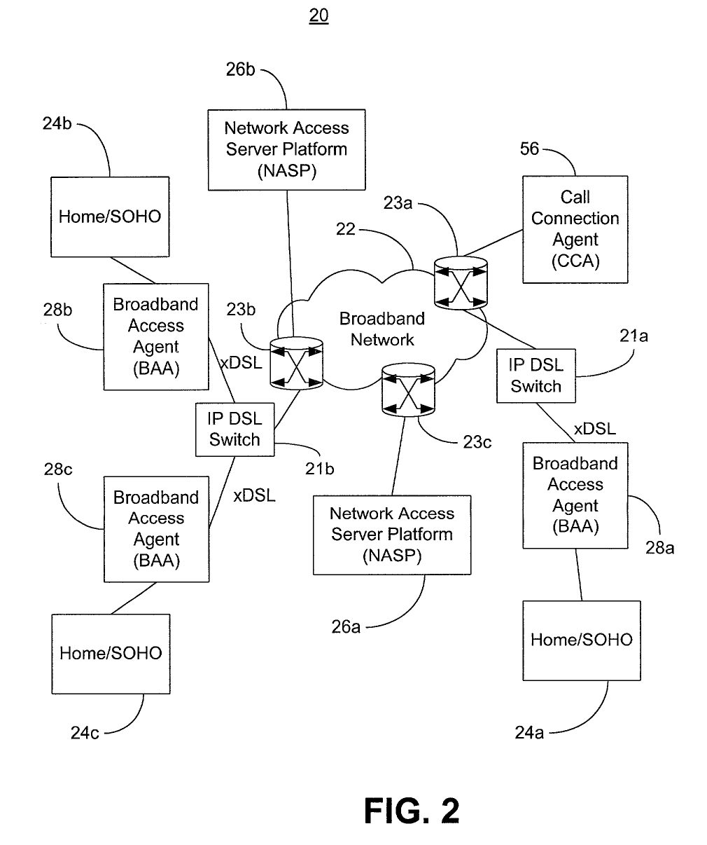

Turning now to FIG. 2, a networking architecture 20 is shown. The architecture 20 utilizes a packet switched broadband network 22 to deliver telecommunication services to one or more small office/home office (SOHO) environments 24a-24c. While some embodiments will be discussed with regard to video conferencing, it should be noted that the embodiments of the invention are not so limited. In fact, the telecommunication services may be either network centric or provide specific, and can include but are not limited to voice applications, data applications, video applications, multimedia applications or any combination thereof. Notwithstanding, there are a number of aspects of video conferencing for which the systems and methods discussed herein are uniquely suited.

Generally, the architecture 20 includes one or more broadband access agents (BAA's) 28a-28c, one or more network access service platforms (NASP's) 26a-26b, one or more Internet protocol (IP) digital subscriber line (DSL) switches 21a-21b, and one or more routing devices 23a-23c. As will be discussed in greater detail below, an NASP is a network centric service element that provides interworking functions between one or more network access entities located in environments 24, a content services provider (not shown) and the broadband network 22 to facilitate services and applications. Thus, each NASP has the capability of providing subscribers with the ability to access the services.

It will be appreciated that the interaction procedures that locate and deliver services, as well as the methodologies that allow the introduction of advanced services in a distributed intelligent manner are given a particular focus on mobility management. Specifically, subscribers can customize their telecommunication needs, such as service and feature selections, maintenance of personal address books and directories, profiles and databases and service preferences by programming the NASP 26 at their convenience. The NASP assists the subscriber in accessing the telecommunication services via the broadband network 22 and replaces the traditional dial tone and telephone key pad with technologies such as speech coding, interactive voice, voice recognition, and text-to-speech processing. When the user wishes to request a telecommunication service, the user merely picks up a phone, turns on a laptop/personal computer (PC) or initiates the NASP application. As a result, the user can interact with the NASP instantaneously/directly via one of the premise-based BAA's 28a-28c to fulfill, initiate and terminate the service requests in a multi-session and multi-application. The NASP, on behalf of the user, interacts with the broadband network 22 and the BAA to deliver a network centric or provider specific service to the mobile terminal. Each user can program, via a web-based service management dialog or through an interactive voice session supported by the NASP/BAA, and the NASP provides personalized services to the user on-demand. The NASP also obliterates the necessity of consumers programming each of their communication devices with their preferences (unless they so desire).

An important aspect of the architecture 20 is the ability of the subscriber to receive services any time, anywhere and by any mechanism (i.e., not just when the subscriber is at home). In other words, mobility management enhances the overall services to the subscriber and is important for widespread acceptance and usage. Generally, mobility management is accomplished when the portable upgrade module, which is installed in a remote terminal, registers with a visiting BAA (or remote access agent) and the subscriber's home NASP. The remote access agent forwards the registration message to the subscriber's home NASP. The home NASP updates the subscriber's location (i.e., based on the assigned IP address), and routes all services including incoming calls to the subscriber in the remote environment. Additionally, since the remote access agent knows the capabilities of the remote terminal, it can allocate additional resources to support the terminal. As a result, the subscriber can access all services as if the subscriber were in the home environment.

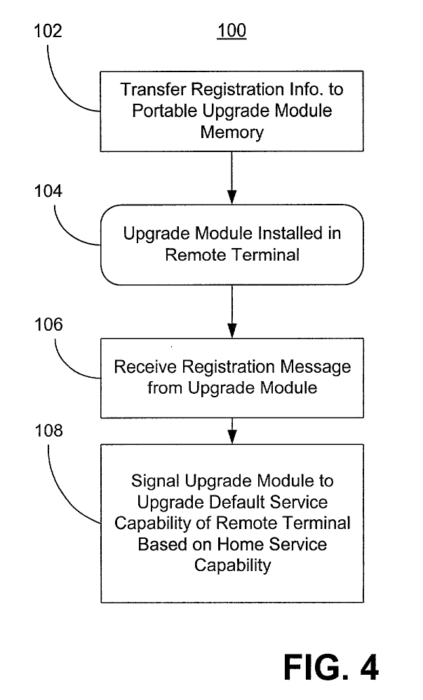

FIG. 4 generally shows a method 100 that can be used to implement an NASP that communicates with a portable upgrade module 10 (FIG. 1). Specifically, it can be seen that the computer-implemented method 100 of supporting a broadband telecommunication service involves transferring registration information such as user verification data, to a memory of a portable upgrade module at processing block 102. This is typically done when the subscriber is located in the home environment, but other locations are also possible. Once the registration information is stored to the upgrade module memory, the subscriber is free to use the upgrade module to personalize the services of any terminal designed to accept the module. For example, the upgrade module may be implemented in a smart card. In such case, any terminal having a smart card reader can use the module to upgrade the services available to that terminal. It is well documented that smart cards contain a processor that offers multiple functions such as encryption, advanced security, local data processing, complex calculations and other interactive processes. As another example, the upgrade module may be implemented in a personal computer (PC) card, or Personal Computer Memory Card International Association (PCMCIA) card. In such case terminals, laptops, etc., having a PC card slot can use the portable upgrade module to enhance services. PC cards have the same characteristics as smart cards, but they are often used as peripheral devices such as modems or game cartridges.

Block 104 illustrates that the upgrade module is installed in a remote terminal by the user, and block 106 provides for receiving a registration message from a network such as a packet switched network. As already discussed, the home NASP is associated with the home environment. Block 108 provides for transmitting a signal to cause the upgrade module to change a default service capability of the remote terminal, which is located in the remote environment, based on the home service capability. The changed default service capability enables the remote terminal to receive the telecommunication service in accordance with the home service capability.

It should be noted that while the embodiments discussed herein primarily involve the case of the home service capability being more desirable to the user than the default service capability, other scenarios may exist. For example, the home service capability could be the same as the default service capability. In such case, no changes to the default service capability would be necessary. Furthermore, the home service capability could be less desirable to the user than the default service capability. In such case, the upgrade module would effectively function as a “downgrade” module by reducing the capabilities of the remote terminal. Alternatively, the user may forego the use of the upgrade module altogether.

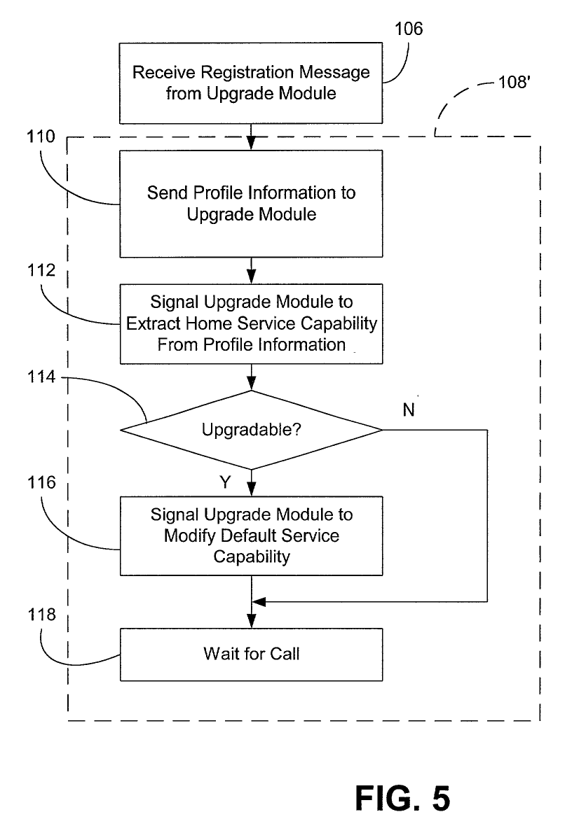

FIG. 5 shows one approach to signaling the upgrade module to upgrade the default service capability in greater detail at block 108′. Specifically, profile information is sent by the home NASP over the packet switched network to the upgrade module at block 110. Block 112 provides for signaling the upgrade module to extract the home service capability from the profile information. This can be done when the profile information is sent. If it is determined that the default service capability can be upgraded to the home service capability at block 114, the default service capability is modified at block 116 based on the home service capability. The determination at step 114 can be made by the upgrade module, the remote access agent, the home NASP, or any combination thereof. Furthermore, the modification signaling can also be done when the profile information is sent. At block 118, the remote terminal is placed in a wait state.

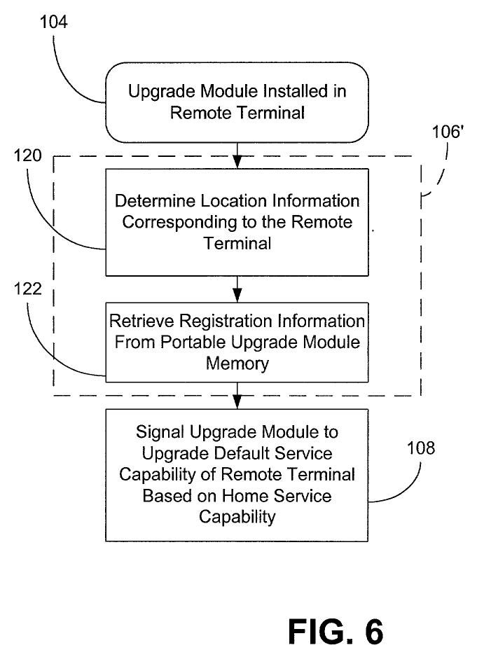

Turning now to FIG. 6, one approach to receiving the registration message at the home NASP is shown in greater detail at block 106′. Specifically, it can be seen that block 120 provides for determining location information corresponding to the terminal, such as an internet protocol (IP) address of the terminal. Registration information is retrieved from the registration message at block 122, where the registration information includes user verification data.

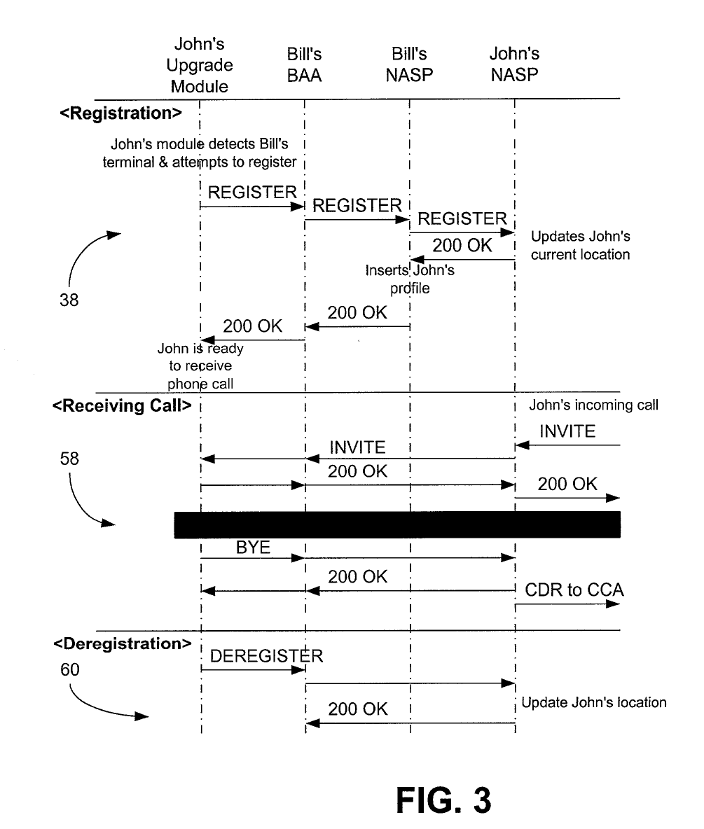

FIG. 3 illustrates a specific mobility management scenario at timing diagram 36 to demonstrate the benefits associated with the principles described herein in greater detail.

With continuing reference to FIGS. 1-3, suppose subscriber “John” has video telephony services for his home environment 24a. He is expecting an important business video call from overseas. However, he is visiting his friend Bill. John inserts his upgrade module into Bill's videophone. Bill's videophone is the entry model, low-cost version with minimal feature set, memory, and capabilities (e.g., supports 64 Kbps video). John's upgrade module 10 upgrades the videophone to support 384 Kbps video with conferencing capabilities. John's upgrade module 10 contacts John's NASP 24a, and after an authentication process, his NASP 24a knows that John is now reachable at Bill's house and the capabilities of the associated telephone. In the mean time, Bill is still able to receive his services on the same telephone with its original capabilities (i.e., not the capabilities enhanced by John's upgrade module). When John's NASP 24a receives the business call, the NASP 24a routes the call to Bill's videophone. After John finishes, John's NASP 24a will forward the call detail record (CDR) to the call-connection agent (CCA). Simply put, John can use the videophone as though it were his own, and all his services originated/received by John are charged to his account. John can conduct his business seamlessly anywhere, anytime without interruption. After John is finished with his call, John just needs to remove his upgrade module 10 from the remote terminal. This will inform the John's NASP 24a that John is no longer reachable at Bill's house, and the NASP 24a should use the previously stored information customized by John, to contact him regarding incoming services.

Thus, the upgrade module 10 and its network interactions enables subscribers to received their associated network-centric based services in a wide variety of surroundings such as residential, SOHO, business, and public environments. The upgrade module 10 allows each subscriber to customize his/her telecommunication equipment needs/capabilities in the area of services and feature selections, etc. The network 22 interacts with the upgrade module 10 to complete the delivery of services to the user. Each user can program the upgrade module 10 via for example a web-based service management dialogue, and the upgrade will provide personalized services to the user. The upgrade module 10 also obliterates the necessity of consumers programming each of their communication devices with their preferences (unless they so desire).

Key aspects of the upgrade module 10 include a distributed service architecture for mobility in a distributed packet based network; methodologies to manage mobility; signaling and messages necessary for services between NASPs and the upgrade module.

The systems and methods discussed above constitute a significant improvement with regard to providing enhanced end-to-end packet telephony and traditional telecommunication services with distributed end-to-end packet network environments. Since the transport methodology is irrelevant to the overall NASP and mobility management service concepts, the asynchronous transfer mode (ATM) with cell-based transport, frame relay network and IP based transport methodology from the environments are also applicable. The above methods and systems are applicable to current and future residential, SOHO, local and enterprise subscribers. They integrate residential and business services, and broadband networks to provide mobility for end-to-end packet/cell/frame-based services.

Those skilled in the art can now appreciate from the foregoing description that the broad teachings of the embodiments of the present invention can be implemented in a variety of forms. Therefore, while the embodiments have been described in connection with particular examples thereof, the true scope of the invention should not be so limited since other modifications will become apparent to the skilled practitioner upon a study of the drawings, specification, and following claims.

What is claimed is:

1. A method of supporting a broadband telecommunication service, the method comprising:
receiving a registration message from a portable upgrade module when the upgrade module is connected to a remote terminal which is located in a remote environment, the upgrade module having a home terminal with a home service capability; and
transmitting a signal to cause the upgrade module to change a default service capability of the remote terminal based on the home service capability, the changed default service capability enabling the remote terminal to receive the telecommunication service in accordance with the home service capability.

2. The method of claim 1 further including:
sending profile information to the upgrade module over a network, the profile information enabling the upgrade module to extract the home service capability, and modify the default service capability based on the home service capability.

3. The method of claim 2 wherein the signal further causes the upgrade module to retrieve the default service capability from the remote terminal, and determine whether the default service capability can be upgraded to the home service capability.

4. The method of claim 1 further including:
determining location information corresponding to the remote terminal based on the registration message; and
determining user verification data based on the registration message.

5. The method of claim 4 further including determining an Internet protocol (IP) address of the terminal.

6. The method of claim 4 further including receiving the registration message via a remote access agent, the remote access agent being associated with the remote environment.

7. The method of claim 6 further including receiving the registration message via a remote network access server platform (NASP), the remote NASP being associated with the remote environment.

8. The method of claim 1 further including transferring registration information to a memory of the portable upgrade module when the upgrade module is connected to the home terminal.

9. The method of claim 8 further including transferring user verification data to the memory of the upgrade module.

10. The method of claim 1 wherein the upgrade module is a smart card.

11. The method of claim 1 wherein the upgrade module is a personal computer (PC) card.

12. The method of claim 1 further including receiving the registration message over a packet switched network.

13. The method of claim 1 further including changing a default video conferencing service capability of a videophone.

14. A method of upgrading a default service capability of a terminal located in a remote environment, the method comprising:
sending profile information to a portable upgrade module over a network, the profile information enabling the upgrade module to extract a home service capability, and modify the default service capability based on the home service capability.

15. The method of claim 14 further including:
signaling the upgrade module to retrieve the default service capability from the terminal; and
signaling the upgrade module to determine whether the default service capability can be upgraded to the home service capability.

16. The method of claim 14 further including sending the profile information to a smart card.

17. The method of claim 14 further including sending the profile information to a personal computer (PC) card.

18. A method of supporting a broadband telecommunication service, the method comprising:
transferring registration information to a memory of a portable upgrade module connected to a home terminal having a home video conferencing capability, the registration information including user verification data;
receiving a registration message from the upgrade module via a remote access agent and a remote network access server platform (NASP) when the upgrade module is connected to a remote terminal which is located in a remote environment;
determining location information corresponding to the remote terminal based on the registration message, the location information including an Internet protocol (IP) address of the remote terminal;
determining user verification data based on the registration message;
sending profile information to the upgrade module over a packet switched network, the profile information enabling the upgrade module to extract the home video conferencing capability from the profile information and modify a default video conferencing capability of the remote terminal based on the home video conferencing capability.

19. The method of claim 18 further including:
signaling the upgrade module to retrieve the default service capability from the videophone; and
signaling the upgrade module to determine whether the default video conferencing capability can be upgraded to the home video conferencing capability.

20. A machine readable storage medium storing a set of instructions capable of being executed by a processor to support a broadband telecommunication service to:
receive a registration message from a portable upgrade module when the upgrade module is connected to a remote terminal which is located in a remote environment, the upgrade module having a home terminal with a home service capability; and
transmit a signal to cause the upgrade module to change a default service capability of the remote terminal based on the home service capability, the changed default service capability enabling the remote terminal to receive the telecommunication service in accordance with the home service capability.

21. The storage medium of claim 20 wherein the set of instructions are further capable of being executed by the processor to:
send profile information to the upgrade module over a network, the profile information enabling the upgrade module to extend the home service capability, and modify the default service capability based on the home service capability.

22. The storage medium of claim 20 wherein the upgrade module is a smart card, the smart card including the storage medium.

23. The storage medium of claim 20 wherein the upgrade module is a personal computer (PC) card, the PC card including the storage medium.
